(19) United States
(12) Patent Application Publication
(10) Pub. No.: US 2025/0352311 A1
(43) Pub. Date: Nov. 20, 2025

(54) VIRTUAL DENTAL BRIDGE

(71) Applicant: James R. Glidewell Dental Ceramics, Inc., Newport Beach, CA (US)

(72) Inventors: Sergei Azernikov, Irvine, CA (US); Stanislav Shushkevich, Newport Beach, CA (US)

(73) Assignee: James R. Glidewell Dental Ceramics, Inc., Newport Beach, CA (US)

(21) Appl. No.: 18/665,272

(22) Filed: May 15, 2024

(51) Int. Cl. A61C 13/00; A61C 7/00; G06T 17/00

(52) U.S. Cl. CPC A61C 13/0004; G06T 17/00; A61C 2007/004

(57) ABSTRACT

A computer-implemented method and system for dental bridge reconstructions include receiving an order for a plurality of single dental units for reconstruction, receiving a 3D virtual model of each jaw of a patient's dentition, and providing virtual reconstructions of the plurality of single dental units as part of a virtual dental bridge.

### BACKGROUND

Dental bridges can include two or more dental units to help restore the appearance of two or more teeth in a patient's dentition. Dental bridges typically include at least one restoration that anchors or connects the bridge to a patient's dentition, and other elements that connect to the at least one anchoring restoration. The restoration can be of any type, including but not limited to crowns, for example. The anchoring restorations typically have a cavity that is used to mount the restoration to either an implant or a prepared tooth. The other elements of the bridge connected to the anchoring restoration can include additional restorations and/or pontics. Pontics typically lack a cavity, and can be used to replace an entire tooth. Pontics are typically connected to either other pontics or restorations on either side of the pontic.

Design of dental bridges can be challenging due to the arch of a patient's jaw. As interconnected elements are added to a dental bridge, adherence to the curve of the patient's jaw by the dental units within the dental bridge can become more challenging. Thus, design of dental bridges can present alignment issues with respect to dental units within the arch of a patient's jaw.

### SUMMARY

Disclosed is a computer-implemented method for dental bridge reconstructions. The method can include receiving an order for a plurality of single dental units for reconstruction, receiving a 3D virtual model of each jaw of a patient's dentition, and providing virtual reconstructions of the plurality of single dental units as part of a virtual dental bridge.

Also disclosed is a non-transitory computer readable medium storing executable computer program instructions to provide dental bridge reconstructions. The computer program instructions can include instructions for: receiving an order for a plurality of single dental units for reconstruction, receiving a 3D virtual model of each jaw of a patient's dentition, and providing virtual reconstructions of the plurality of single dental units as part of a virtual dental bridge.

Also disclosed is a system to provide one or more dental bridge reconstructions. The system can include a processor, and a non-transitory computer-readable storage medium comprising instructions executable by the processor to perform steps that can include: receiving an order for a plurality of single dental units for reconstruction, receiving a 3D virtual model of each jaw of a patient's dentition, and providing virtual reconstructions of the plurality of single dental units as part of a virtual dental bridge.

### BRIEF DESCRIPTION OF THE DRAWINGS

FIG. 1 is a flowchart of one or more steps in some embodiments.

FIG. 2 is a diagram of a deep neural network in some embodiments.

FIG. 3(a) is a diagram of a ResNet neural network in some embodiments.

FIG. 3(b) is a diagram of an example of a portion of a ResNet neural network in some embodiments.

FIG. 4 shows a diagram a U-Net neural network in some embodiments.

FIG. 5 shows a computer Graphical User Interface for selecting virtual single dental units as part of a virtual dental bridge in some embodiments.

FIG. 6 shows a representation of a virtual jaw in standard alignment based on teeth centers of an etalon jaw in some embodiments.

FIG. 7 shows at least a portion of a virtual jaw with one or more rough pontic positions in some embodiments.

FIG. 8(a) shows at least a portion of a virtual jaw with one or more rough pontic positions prior to virtual hat generation in some embodiments.

FIG. 8(b) shows at least a portion of a virtual jaw after virtual hat generation in some embodiments.

FIG. 9 shows at least a portion of a virtual jaw with generated pontics and restorations within the virtual hat in some embodiments.

FIG. 10(a) and FIG. 10(b) show screenshots of the generated virtual dental bridge displayed in CAD/CAM software in some embodiments.

FIG. 11 is a diagram of a system in some embodiments.

### DETAILED DESCRIPTION

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the terms “coupled” and “associated” generally mean electrically, elecfromagnetically, and/or physically (e.g., mechanically or chemically) coupled or linked and does not exclude the presence of intermediate elements between the coupled or associated items absent specific contrary language.

In some examples, values, procedures, or apparatus may be referred to as “lowest,” “best,” “minimum,” or the like. It will be appreciated that such descriptions are intended to indicate that a selection among many alternatives can be made, and such selections need not be better, smaller, or otherwise preferable to other selections.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

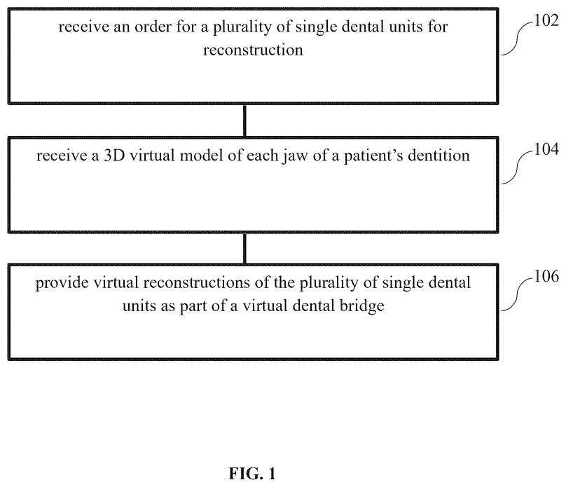

Some embodiments can include a computer-implemented method for virtual dental bridge reconstructions. The computer-implemented method can include receiving an order for a plurality of single dental units for reconstruction, receiving a 3D virtual model of each jaw of a patient's dentition, and providing one or more virtual reconstructions of the plurality of single dental units as part of a virtual dental bridge. As shown in FIG. 1, the computer-implemented method can receive an order for a plurality of single dental units for reconstruction 102, receive a 3D virtual model of each jaw of a patient's dentition 104, and provide virtual reconstructions of the plurality of single dental units as part of a virtual dental bridge 106. The order can be received electronically from a Graphical User Interface (“GUI”) in some embodiments, and/or read from a digital file, database, or other computer storage media known in the art. In some embodiments, the steps can be performed in any order. In some embodiments, the steps are performed sequentially.

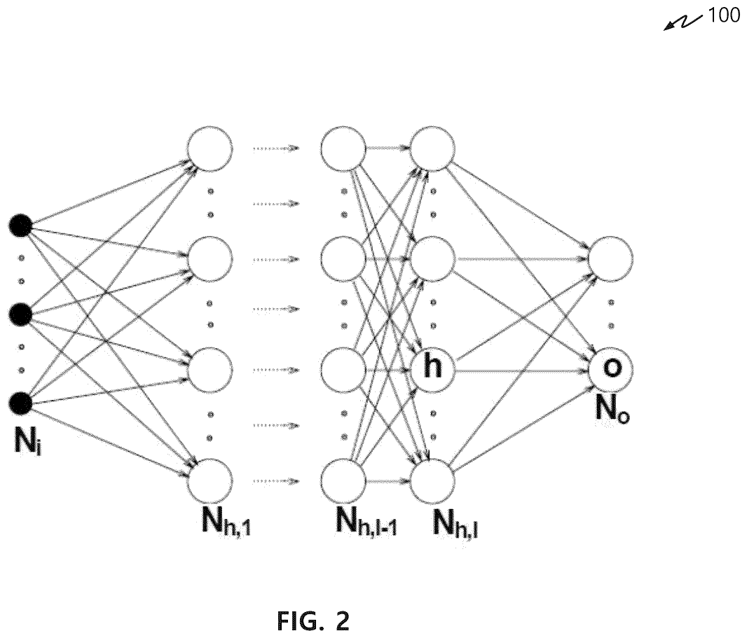

In some embodiments a computer-implemented method for dental bridge reconstructions can use one or more neural networks. In some embodiments, the neural network can include a deep neural network (“DNN”). Referring now to FIG. 2, which is a high-level block diagram showing structure of a deep neural network (DNN) 400 according to some embodiments of the disclosure. DNN 100 includes multiple layers Nᵢ, N_{h,1}, N_{h,1-1}, N_{h,1}, Nₒ, etc. The first layer Nᵢ is an input layer where one or more dentition scan data sets can be ingested. The last layer Nₒ is an output layer. The deep neural networks used in the present disclosure may output probabilities. For example, the output can be a probability vector that includes one or more probability values of each feature or aspect of the dental models belonging to certain categories.

Each layer N can include a plurality of nodes that connect to each node in the next layer N+1. For example, each computational node in the layer N_{h,1-1} connects to each computational node in the layer N_{h,1}. The layers N_{h,1}, N_{h,1-1}, N_{h,1}, between the input layer Nᵢ and the output layer Nₒ are hidden layers. The nodes in the hidden layers, denoted as “h” in FIG. 2, can be hidden variables. In some embodiments, DNN 100 can include multiple hidden layers, e.g., 24, 30, 50, etc.

In some embodiments, DNN 100 may be a deep feedforward network. DNN 100 can also be a convolutional neural network, which is a network that uses convolution in place of the general matrix multiplication in at least one of the hidden layers of the deep neural network. DNN 100 may also be a generative neural network or a generative adversarial network. In some embodiments, training may use training data set with labels to supervise the learning process of the deep neural network. The labels are used to map a feature to a probability value of a probability vector. Alternatively, training may use unstructured and unlabeled training data sets to train, in an unsupervised manner, generative deep neural networks that do not necessarily require labeled training data sets.

In some embodiments, the DNN can be a multi-layer perceptron (“MLP”). In some embodiments, the MLP can include 4 layers. In some embodiments, the MLP can include a fully connected MLP. In some embodiments, the MLP utilizes BatchNorm normalization.

In some embodiments, the computer-implemented method can use one or more deep neural networks known in the art, such as ResNet neural network(s) and U-Net neural network(s).

In some embodiments, any type of ResNet architecture can be used. One example of ResNet architecture is described in ResNets, by Pablo Ruiz—Harvard University, August 2018, the entirely of which is incorporated by reference herein. In some embodiments, the ResNet neural network can be ResNet-50.

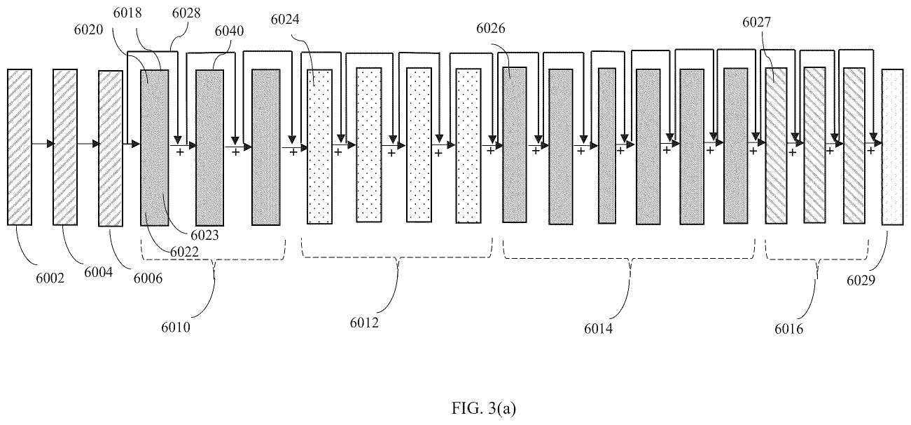

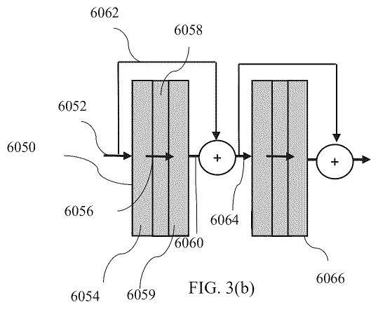

FIG. 3(a) illustrates one example of a ResNet-50 neural network. An input image 6002 can be provided to a first ResNet convolution layer Conv-1 6004, In some embodiments, the first ResNet convolution layer can be a 7×7 convolution with 64 channels and a stride of 2. In some embodiments, this can be followed by a pooling step 6006 with a stride of 2. Some embodiments of the ResNet neural network can include, for example, four additional ResNet stages, or layers, that can each perform one or more 3×3 convolutions, bypassing the input every two convolutions. The height and width dimensions (i.e. image resolution) as well as the number of channels (feature map dimension) can remain the same within each stage.

FIG. 3(a) illustrates an example of a ResNet-50 neural network that can include five stages: Conv-1 6004, Res-2 6010, Res-6012, Res-4 6014, and Res-5 6016. Each block in the Res-2 6010, Res-3 6012, Res-4 6014, and Res-5 6016 stages represents a set 1×1, 3×3, and 1×1 convolutions performed in series (i.e. the output of the first convolution is the input of the second convolution within each box). For example, a first block 6018 can include a first Res-2 convolution 6020, a second Res-2 convolution 6022, and a third Res-2 convolution 6023 performed in series. In some embodiments, the first convolution in a first block of one or more ResNet stages can increase the stride from 1 to 2. For example, a first Res-3 convolution 6024 in stage Res-3 6012, a first Res-4 convolution 6026 in stage Res-4 6014, and a first Res-5 convolution 6027 in stage Res-5 6016 can each use a stride of 2, with the remaining convolutions using a stride of 1. In some embodiments, the ResNet stages can perform bypassing. In bypassing, the input of a first block is added to the output of the first block and the sum is provided as input to the next block. For example, as illustrated in FIG. 3(a), input to first block 6018 bypasses via bypass 6028 the first block and is added to an output of the first block 6018. This sum is then provided as input to a next block 6040.

FIG. 3(b) illustrates an example of bypassing in more detail, A first block 6050 can receive a first block input feature map 6052. The input image 6052 can undergo a first convolution 6054 such as a 1×1 convolution, for example, and provide a first convolution output 6056 which can undergo a second convolution 6058, whose output can undergo a third convolution 6059 to provide a first block output 6060. The ResNet neural network can, via bypass 6062, sum the first block input feature map 6052 with the first block output 6060 and provide the sum as a second block input feature map 6064 to a second block 6066. This pattern can be repeated throughout the ResNet stages as illustrated in FIG. 3(a).

Referring to FIG. 3(a), the Conv-1 6004 stage can output an image size of 112×112 after performing a 7×7, 64 channel, stride 2 convolution.

The Res-2 6010 stage can include 3 blocks, with each block performing a 1×1, 64 channel convolution followed by a 3×3 64 channel convolution, followed by a 1×1, 256 channel convolution, and output an image size of 56×56.

The R-es-3 6012 stage can include 4 blocks, with each block performing a 1×, 128 channel convolution, followed by a 3×3, 128 channel convolution, followed by a 1×, 512 channel convolution, and output an image size of 28×28.

The Res-4 6014 stage can include 6 blocks, with each block performing a 1×1, 256 channel convolution, followed by a 3×3, 256 channel convolution, followed by a 1×1, 1024 channel convolution, and output an image size of 14×14.

The Res-5 6016 stage can include 3 blocks, with each block performing 1×1, 512 channel convolution, followed by a 3×3, 512 channel convolution, followed by a 1×, 2048 channel convolution, and output an image size of 7×7. Finally, the pooling stage 6029 can perform average pooling in some embodiments, 1000-d fc, softmax to output a 1×1 image size.

In some embodiments, the computer-implemented method can use U-Net. U-Net is a convolutional neural network that can be used for biomedical image segmentation and/or for image generation in two dimensions (2D), and is described in U-Net: Convolutional Networks for Biomedical Image Segmentation, by, Olaf Ronneberger, Philipp Fischer, and Thomas Brox, Computer Science Department and BIOSS Centre for Biological Signalling Studies, University of Freiburg, Germany, arXiv, 18 May 1015, the entirety of which is hereby incorporated by reference. In some embodiments, U-Net is used to generate images in 2D, such as 2D surface image generation. Standard CNNs typically include one or more convolution/pooling layers, known as contracting layers. The U-Net architecture can combine the one or more convolution/pooling contracting layers with one or more convolution/up-sampling layers. The U-Net architecture can thus increase resolution output. Localization can be achieved by combining high resolution features from the contracting path with the up sampled output. The U-Net architecture can also include a large number of feature channels to provide context information to higher resolution layers. In some embodiments, the expansive path can be symmetric to the contracting path, thereby providing a U-shaped architecture,

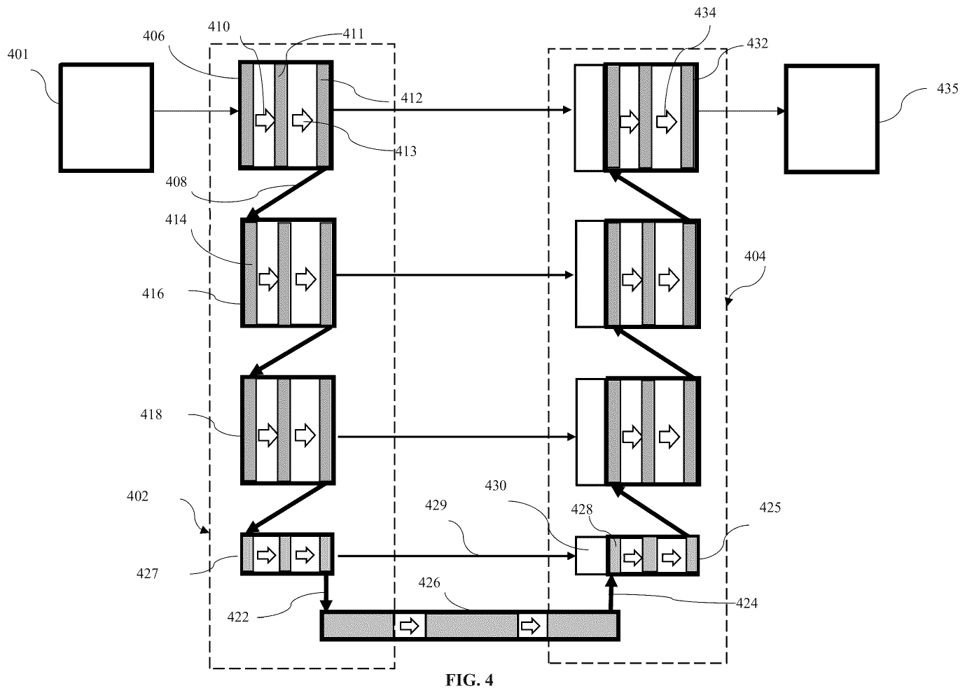

FIG. 4 illustrates one example of a U-Net CNN that includes a contracting path 402 and an expanding path 404 in some embodiments. The contracting path 402 can include one or more convolution layers, such as first convolution layer 406, Each convolution layer can perform one or more convolutions, such as first convolution 410. The convolution can utilize a kernel of any size. In some embodiments, for example a 3×3 kernel can be used to perform the one or more convolutions. In some embodiments, each convolution layer can perform two convolutions.

In some embodiments, each convolution can generate a feature map, and each feature map can include one or more feature channels. In some embodiments, each convolution within a convolution layer in the contracting path can maintain the same number of feature channels. For example, the network can receive an input image 401 that can have an image resolution and n number of feature channels. In convolution layer 406, first convolution 410 can provide a n-channel feature map such as first feature map 411, and second convolution 413 can provide an n-channel feature nap such as last feature map 412. Both a first feature map 411 and a last feature map 412 can include n-channels. In some embodiments, each convolution can be unpadded. In some embodiments, one or more convolutions can be padded. Each of the one or more convolutions can also be followed by an activation function such as ReLu, or other activation functions known in the art.

The U-Net CNN can also include performing a pooling operation such as first pooling operation 408. The pooling operation in some embodiments can down sample each feature map. The pooling operation can in some embodiments be performed on a last feature map generated after a last convolution in the particular convolution layer. For example, in FIG. 4, the first pooling operation 408 can be performed on the last feature map 412, and the result can be a convolution layer input 414 to a next convolution layer 416. The first pooling operation 408 can be any pooling operation known in the art. For example, in some embodiments, the first pooling operation 408 can be a max pooling operation. In some embodiments, the first pooling operation 408 can be an average pooling operation. The pooling operation can be any value. For example, in some embodiments, the pooling operation can be a 2×2 pooling operation with a stride of 2.

In some embodiments, each pooling operation can optionally be followed by additional convolution layers and pooling operations. For example, first pooling operation 408 can be followed by a second convolution layer 416, which can be followed by a third convolution layer 418, and a fourth convolution layer 427, with pooling operations between each convolution layer. In some embodiments, the number of feature channels can be doubled with each convolution layer in the contracting path 402, For example, second convolution layer 416 can double the number of feature channels to twice that of the first convolution layer 406, third convolution layer 418 can double the number of feature channels to twice that of the second convolution layer 416, and fourth convolution layer 422 can double the number of feature channels to twice that of the third convolution layer 418. This can provide 2*n feature channels for each feature map produced by each convolution layer in the contracting path 402. For example, the first convolution layer 406 can receive an input image having 1 channel and after performing one or more convolutions, can produce a feature map having 64 channels, the second convolution layer 416 can provide a feature map having 128 channels after performing one or more convolutions, the third convolution layer 418 can provide a feature snap having 256 channels after performing one or more convolutions, and the fourth convolution layer 418 can provide a feature map having 512 channels, for example. Dimensions of the image can be reduced at each convolution. For example, the input image can have a resolution of 572×572 The first convolution 410 can provide the feature map 411 with a resolution of 570×570. The second convolution can provide the last feature map 412 with a resolution of 568×568. In some embodiments, each pooling operation between convolution layers can decrease the resolution by ½. For example, the first pooling operation 408 can reduce the last feature map 412 with a resolution of 568×568 to the convolution layer input 414 having a resolution of 284×284.

The U-Net CNN can perform a final pooling operation 422 in the contracting path 402 on the final contracting path convolution layer 427. The U-Net CNN can perform one or more convolutions at a convolution layer 426. In some embodiments, the input to convolution layer 426 can have a resolution of 32×32 with 1024 feature channels. The output from convolution layer 426 can be a feature map having a resolution of 2×28 with 1024 feature channels.

The U-Net CNN can perform up-sampling of the feature map in the expansive path 404. The expansive path 404 can include one or more up-sampling layers, such as up-sampling layer 425. Each up-sampling layer can halve the number of feature channels. For example, up-sampling 424 can halve the number of feature channels for a last feature map from convolution layer 426 to provide feature map 428. The up-sampling can be 2×2 up-convolution, for example.

Each up-sampling layer can concatenate a cropped feature map from the contracting path. For example, up-sampling layer 425 can perform a concatenating operation 429 to concatenate cropped feature map 430 from the contracting path 424 to the up-sampled feature map 428. Each up-sampling can double the resolution of the feature map from the previous up-sampling layer.

For example, up-sampling 424 can double the feature map resolution from convolution layer 426 to provide feature map 428, As an example, where the last feature map from convolution layer 426 is 28×28, the feature map 428 can be 56×56 after up-sampling 424. Each up-sampling layer can also perform one or more convolutions, each of which can be followed by an activation function such as ReLU, or any other activation function known in the art. The convolutions within each up-sampling layer can be 3×3 convolutions, for example. The U-Net CNN can perform a 1×1 convolution as the last convolution in the final up-sampling layer. For example, final up-sampling layer 432 can include last convolution 434 that can provide output segment map 435 for example in some embodiments. In some embodiments, the output map 435 can have a resolution of 388×388 and include 2 channels, for example.

In some embodiments, each up-convolution layer can be preceded by up-sampling.

In some embodiments. U-Net CNN training can determine the energy function as sum_{x,y}{(pic∧target_{x,y}−pic∧{predicted}_{x,y})∧2}.

In some embodiments, the computer-implemented method for dental bridge reconstructions can include receiving an order for a plurality of single dental units for reconstruction. In some embodiments, the plurality of single dental units can be for a virtual dental bridge. In some embodiments, the plurality of single dental units can include one or more virtual restorations and one or more virtual pontics adjacent to and/or between the at least one or more virtual restorations. In some embodiments, the one or more virtual restorations can include virtual crown, for example. In some embodiments, a virtual pontic can be a single dental unit lacking a cavity.

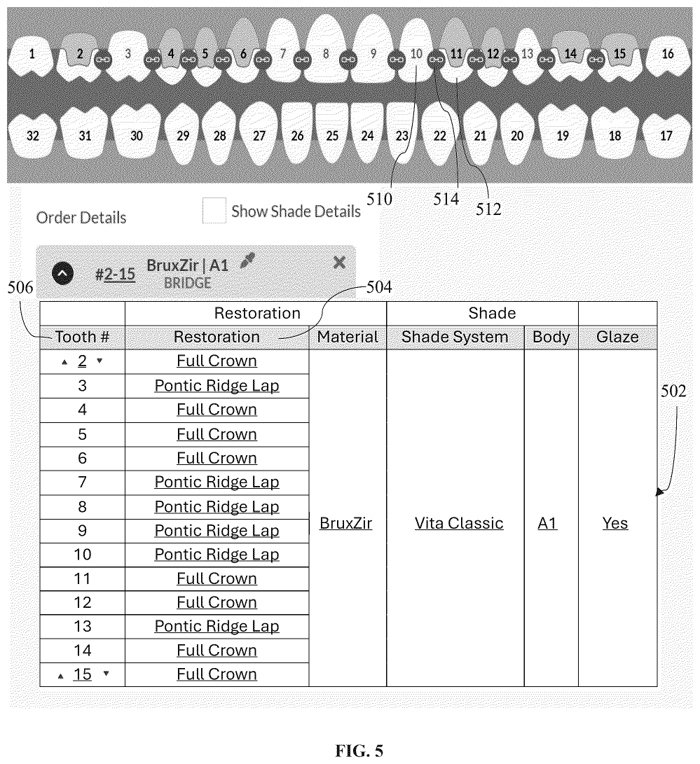

FIG. 5 shows a computer Graphical User Interface (GUI for selecting virtual single dental units as part of a virtual dental bridge in some embodiments. The GUI can provide a window 502 to select a single dental unit 504 (such as a crown, pontic, or any other dental unit type/restoration) for one or more tooth numbers 506 to be part of a bridge. Another section of the GUI can virtually display representations of the upper and lower teeth, along with representations for the type of single dental unit selected, and an indicator displaying the bridge to which they are connected. For example, in FIG. 5, a virtual upper jaw shown can include a virtual pontic 510 selected for virtual tooth number 10 and a virtual crown 512 selected for virtual tooth number 11, connected by a bridge indicator 514.

In some embodiments, any number of virtual pontics/virtual restorations can be used. In some embodiments, up to 14 virtual pontics/restorations for the maxillary jaw and 14 virtual pontics/restorations for the mandibular jaw can be used.

In some embodiments, the virtual dental bridge can include at least one virtual pontic and one virtual dental reconstruction unit. In some embodiments, the one virtual dental reconstruction unit can include a virtual crown. In some embodiments, a virtual dental bridge with a single virtual crown can be known as a dental cantilever. In some embodiments, the one or more virtual single dental units are connected together to form the virtual dental bridge.

In some embodiments, an order can include a set of Federation Dentaire Internationale (FDI) tooth numbering system teeth IDs to be reconstructed. In some embodiments, the one or more single dental units can include crowns, pontics, inlays, and/or veneers. In some embodiments, the one or more single dental units can include any kind of dental unit/reconstruction without limitation. In some embodiments, the one or more single dental units can include an arbitrary combination of single dental units for reconstruction.

In some embodiments, the computer-implemented method for dental bridge reconstructions can include receiving a 3D virtual model of each jaw of a patient's dentition. In some embodiments, the 3D virtual model of each jaw is can have been generated using any technique known in the art.

In some embodiments, the virtual jaw models can be generated by scanning a physical impression using any scanning technique known in the art including, but not limited to, for example, optical scanning, CT scanning, etc. or by intraoral scanning of the patient's mouth (dentition). A conventional scanner typically captures the shape of the physical impression/patient's dentition in 3 dimensions during a scan and digitizes the shape into a 3 dimensional digital model. The first virtual jaw mode and the second virtual jaw model can each include multiple interconnected polygons in a topology that corresponds to the shape of the physical impression/patient's dentition, for example, for a responding jaw. In some embodiments, the polygons can include two or more digital triangles. In some embodiments, the scanning process can produce STL, PLY, or CTM files, for example that can be suitable for use with a dental design software, such as FastDesign™ dental design software provided by Glidewell Laboratories of Newport Beach, Calif. One example of CT scanning is described in U.S. Patent Application No. US20180132982A1 to Nikolskiy et al., which is hereby incorporated in its entirety by reference.

The first virtual jaw model and the second virtual jaw model can also be generated by intraoral scanning of the patient's dentition, for example. In some embodiments, each electronic image is obtained by a direct intraoral scan of the patient's teeth. This will typically take place, for example, in a dental office or clinic and be performed by a dentist or dental technician. In other embodiments, each electronic image is obtained indirectly by scanning an impression of the patient's teeth, by scanning a physical model of the patient's teeth, or by other methods known to those skilled in the art. This will typically take place, for example, in a dental laboratory and be performed by a laboratory technician. Accordingly, the methods described herein are suitable and applicable for use in chair side, dental laboratory, or other environments.

In some embodiments, the one or more virtual jaws can include a virtual upper jaw and a virtual lower jaw of a patient's dentition. In some embodiments, a reconstruction 3D virtual model can include a virtual jaw under reconstruction. An antagonist 3D virtual model can an antagonist (opposite) virtual jaw to the virtual jaw under reconstruction. In some embodiments, the antagonist 3D virtual model is optional. In some embodiments, the antagonist 3D virtual model provides height information for the virtual single dental units. The height information can avoid intersection of the virtual single dental units with the antagonist virtual jaw teeth.

In some embodiments, the one or more virtual jaws can be segmented into individual teeth and/or other regions. In some embodiments, segmentation of the one or more virtual jaws can be performed using any segmentation technique known in the art. In some embodiments, segmentation of the one or more virtual jaws can be performed by one or more segmentation techniques described in U.S. patent application Ser. No. 16/451,968 of Nikolskiy et al., now U.S. Pat. No. 11,622,843, the entirety of which is incorporated by reference herein. In some embodiments, segmentation of the one or more virtual jaws can be performed by one or more segmentation techniques described in U.S. patent application Ser. No. 17/140,739 of Azernikov, et al., now U.S. patent Ser. No. 11/842,484, the entirety of which is incorporated by reference herein.

In some embodiments, the computer-implemented method for dental bridge construction can include providing virtual reconstructions of the plurality of single dental units ordered as part of a virtual bridge. In some embodiments, providing virtual reconstructions can include determining an occlusion direction in the 3D virtual model of the one or more virtual jaws, aligning a 3D virtual model of a particular virtual jaw under reconstruction to a standard aligned position to provide an aligned virtual jaw, determining rough virtual pontic positions of one or more virtual pontics in the 3D virtual model of the particular jaw under reconstruction, generating a virtual hat to represent a 2D occlusal view for the 3D virtual model for the particular virtual jaw under reconstruction, determining one or more precise virtual pontic positions corresponding to the one or more rough virtual pontic positions using the generated virtual hat to provide one or more corresponding predicted virtual pontic position(s), optionally determining a buccal direction for each virtual pontic/dental unit, and generating one or more virtual single dental units to fit within the generated virtual hat.

In some embodiments, providing virtual reconstructions can include determining an occlusion direction in the 3D virtual model of the one or more virtual jaws. In some embodiments, determining an occlusion direction of the one or more virtual jaws can include determining an anterior occlusion direction and determining a posterior occlusion direction for each virtual jaw. In some embodiments, determining an occlusion direction of the considered virtual jaw can include using a trained occlusal direction neural network. In some embodiments, the trained occlusal direction neural network can include a DNN. In some embodiments, determining an occlusion direction of the considered virtual jaw can include determining a posterior occlusal direction for a posterior region of the considered virtual jaw and determining an anterior occlusal direction for an anterior region of the considered virtual jaw.

In some embodiments, the posterior region can include virtual teeth FDIx8, x7, x6, x5, x4, and “anterior” teeth as FDIx3, x2, x1, where x in {1,2,3,4}. Some embodiments can include determining six two-dimensional views of the considered virtual from centers of sides of a virtual cube surrounding the considered virtual jaw. In some embodiments, the directions of views are parallel to the sides of the virtual cube and directed from the center of virtual cube faces to a center of the cube. In some embodiments, the six two-dimensional views are determined from all sides at once.

In some embodiments, determining the posterior occlusion direction can include using a trained posterior occlusion direction neural network. In some embodiments, the trained posterior occlusion direction neural network is trained to show posterior virtual teeth from the top. In some embodiments, the posterior occlusion direction neural network can include ResNet. In some embodiments, the posterior occlusion direction Neural Network can be trained using a dataset comprising dental cases (such as from a database or a file system, etc.), the input is a set of six 2D projections of the virtual jaw from sides of a cube, and the target is a posterior occlusal direction from the case. In some embodiments, the training dataset can include about 100 k dental cases. Other training dataset sizes can be used.

In some embodiments, determining the posterior occlusion direction can include randomly rotating the considered virtual jaw one or more times, determining the posterior occlusion direction for each rotation, and taking an average of the posterior occlusion directions. In some embodiments, the number of rotations can be 10.

In some embodiments, determining the anterior occlusion direction can include using a trained anterior occlusion direction neural network. In some embodiments, the trained anterior occlusion direction neural network is trained to show anterior virtual teeth from the top. In some embodiments, the anterior occlusion direction is sloped forward to the anterior virtual teeth relative to the posterior occlusion direction. In some embodiments, the anterior occlusion direction neural network can include ResNet. In some embodiments, the anterior occlusion direction neural network is trained using a dataset comprising dental cases from a database with FDIx1 unit, x in {1,2,3,4}, the input is a set of six 2D projections of the virtual jaw from sides of a cube, and the target is an anterior occlusal direction of the FDIx1 unit from the case. In some embodiments, the training dataset can include about 100 k dental cases. Other training dataset sizes can be used.

In some embodiments, determining the anterior occlusion direction can include randomly rotating the considered virtual jaw one or more times, determining the anterior occlusion direction for each rotation, and taking an average of the anterior occlusion directions. In some embodiments, the number of rotations can be 10.

In some embodiments, the posterior occlusion direction and the anterior occlusion direction provide stable and accurate occlusion directions. One or more advantages can include allowing anterior and posterior occlusion directions to both be visible from the top.

In some embodiments, providing virtual reconstructions can include aligning a 3D virtual model of a particular virtual jaw under reconstruction to a standard aligned position to provide an aligned virtual jaw. In some embodiments, aligning the 3D virtual model can include pulling virtual tooth centers on of the reconstruction virtual jaw to virtual tooth centers of a virtual etalon jaw. In some embodiments, virtual etalon jaw can include a maxillary virtual etalon jaw for a maxillary jaw and a mandibular virtual etalon jaw for a mandibular jaw.

In some embodiments, the maxillary virtual etalon jaw and the mandibular virtual etalon jaw are determined from sets of actual virtual jaws. In some embodiments, the actual virtual jaws can be stored in a database or other file structure. In some embodiments, the maxillary virtual etalon jaw can include an average size of a set of actual virtual maxillary jaws, with proper teeth arc, and containing 14 teeth each from FDI17 to FDI27 for maxillary jaw with segmentation of each virtual tooth.

In some embodiments, the mandibular virtual etalon jaw can include an average size of a set of actual virtual mandibular jaws, with proper teeth arc and containing 14 teeth each and from FDI37 to FDI47 for mandibular jaw with segmentation of each virtual tooth.

In some embodiments, a virtual tooth center of a virtual tooth is determined by determining a center-of-mass of a border of the virtual segmented tooth. In some embodiments, the virtual tooth center of a virtual cavity is determined by determining a center-of-mass of a border of the virtual cavity. In some embodiments, aligning the standard aligned position guarantees the virtual jaw under reconstruction to be in a standard location for further operations such as rough pontic position determination and virtual jaw hat construction as described below. In some embodiments, aligning the standard aligned position can include placing initially randomly rotated and shifted virtual jaw to a standard (etalon) position.

In some embodiments, the standard aligned position advantageously allows further processing using one or more trained neural networks. In some embodiments, the one or more trained neural networks utilize the standard aligned object in the etalon position as input. In some embodiments, the standard aligned position can include virtual anterior teeth to be oriented to the right and virtual posterior teeth to be oriented to the left on the occlusal projection and the virtual jaw to be properly centered on the occlusal projection. In some embodiments, the occlusion direction is the posterior occlusion direction. In some embodiments, determining the standard aligned position can include determining a virtual jaw projection onto an occlusal plane. In some embodiments, the occlusal plane is determined based on the posterior occlusion direction. In some embodiments, determining the standard aligned position can include using the known positions of the virtual etalon jaw on the virtual jaw projection, pulling virtual teeth centers of the considered virtual jaw to the corresponding etalon virtual teeth centers (e.g. center of FDI36 of considered jaw to center of FDI36 of the virtual etalon jaw if applicable (tooth FDI36 could be missed on the considered jaw, then we drop this center from the procedure).

In some embodiments, determining a shift and rotation of the considered virtual jaw provides a residual. In some embodiments, the residual can be determined as residual=sum_{points to pull}(r_{etalon point}−r_{point on jaw to pull})∧2, where r is a point in 2D (x,y), and should be minimized under the procedure. In some embodiments, if the residual is greater than a user-configurable threshold, the considered virtual jaw is aligned by using a general view of the virtual teeth arc on the occlusal projection of the considered virtual jaw using an alignment trained Deep neural network (“DNN”). In some embodiments, the alignment trained DNN can include a ResNet DNN. In some embodiments, the occlusal projection is based on the posterior occlusion direction. In some embodiments, the alignment DNN is trained using a dataset comprising dental cases from the database, where the geometrical alignment (“pulling to the etalon centers”) converges with good results (under the threshold), the input is (1) 1D projection from the posterior occlusal direction and (2) centers of preparations, and the target is shift of the center in the occlusal plane and rotation in the occlusal plane from the geometrical alignment.

In some embodiments, aligning the 3D virtual model can include neuroalignment to provide a neuroaligned virtual jaw. In some embodiments, neuroalignment can include: receiving an image comprising general 2D occlusal view of the particular jaw and positions of one or more preparations with corresponding FDI IDs and determining a rotation and a shift of the image to the standard position inherited from the virtual etalon jaw. In some embodiments, separate virtual etalon jaws are used for maxillary and mandibular jaws.

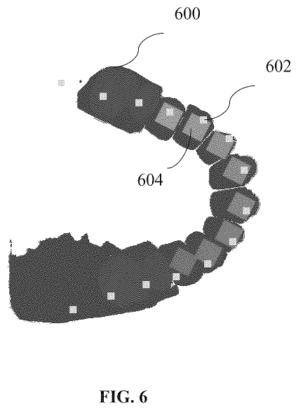

FIG. 6 illustrates a virtual jaw 600 in standard alignment in some embodiments. In the figure, several points show centers of teeth in an etalon jaw, such as etalon jaw tooth center 602, with the virtual jaw 600 in alignment based on the etalon jaw. The virtual jaw 600 can include one or more virtual preparations on the initial virtual jaw, such as virtual preparation 604.

In some embodiments, providing virtual reconstructions can include determining rough virtual pontic positions of one or more virtual pontics on the 3D virtual model of the particular jaw under reconstruction. In some embodiments, a virtual pontic is a middle virtual tooth between two virtual crowns as part of a dental bridge. In some embodiments, determining the rough virtual pontic positions is performed on an aligned virtual jaw. In some embodiments, the aligned virtual jaw is aligned to the standard aligned position.

In some embodiments, each virtual pontic position is predicted separately. In some embodiments, all anterior and posterior virtual pontic positions are predicted at once. In some embodiments, virtual pontic placement prediction is done separately for the virtual maxillary and the virtual mandibular jaw, and for “posterior” (FDIx7-FDIx4+FDIy7-FDIy4, x,y={1,21} or {3,4}) and “anterior” (FDIx3-FDIx1+FDIy3-FDIy1, x,y={1,21} or {3,4}) parts of each virtual jaw. In some embodiments, each virtual pontic position is predicted using one or more trained neural networks on an occlusal projection of the virtual aligned jaw under consideration.

In some embodiments, the one or more trained neural networks can include one or more trained pontic position neural networks. In some embodiments, the one or more neural networks predict pontic positions at once in a particular region of the virtual maxillary jaw and the virtual mandibular jaw. One or more advantages can include improved speed of determining rough pontic positions, for example. In some embodiments, the one or more trained pontic position neural networks can include a DNN. In some embodiments, the DNN can include ResNet. In some embodiments, the one or more trained pontic position neural networks are provided an occlusal projection and identifications of virtual pontics to be placed in the virtual jaw. In some embodiments, the one or more trained pontic position neural networks provide a position for each virtual pontic. In some embodiments, the one or more trained pontic position neural networks can include a trained anterior maxillary virtual pontic position trained neural network. In some embodiments, the one or more trained pontic position neural networks can include a trained posterior maxillary virtual pontic position trained neural network.

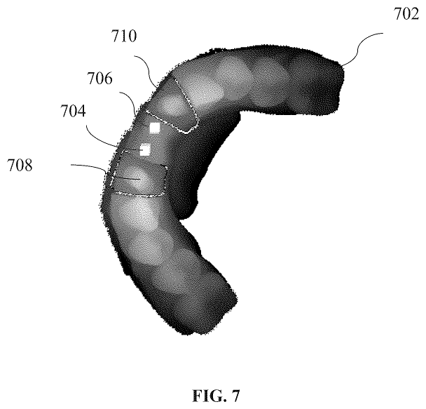

FIG. 7 shows a portion of a virtual jaw with one or more rough pontic positions in some embodiments. Virtual jaw 702 can include a first rough pontic position 704 and a second rough pontic position 706. The virtual jaw 702 also shows a first restoration location 708 and a second restoration location 710.

In some embodiments, the one or more trained pontic position neural networks can include a trained anterior mandibular virtual pontic position trained neural network.

In some embodiments, the one or more trained pontic position neural networks can include a trained posterior mandibular virtual pontic position trained neural network.

In some embodiments, the one or more pontic position neural networks are trained using a dataset comprising dental cases with at least one restoration and the dataset can be enriched with dental cases with multiple restorations. The input can include (1) 1D projection of the jaw from the occlusal direction (posterior or anterior, respectively) (2) the same projection, but with the virtual teeth removed (virtual teeth are recognized by the segmentation of the virtual jaw), and a target can be of a projection to occlusal plane of centers of pontics from the case reconstruction by technician.

In some embodiments, the input (2) can help notify the DNN where the bald gingiva is, as the pontics positions should be on the gingiva. The dataset can include 100 k dental cases.

Some embodiments can include generating a virtual hat for the 3D virtual model for the particular virtual jaw under reconstruction. The virtual hat can be a 2D occlusal view of the 3D model of a virtual jaw from a top direction. In some embodiments, the top direction can be along an occlusion direction. In some embodiments, the virtual hat can include a global concerted view of the virtual reconstructed jaw. In some embodiments, the virtual hat local generation respects a global virtual jaw arc. In some embodiments, the global virtual jaw arc is in the 3D virtual model of a particular virtual jaw, and represents the actual global virtual jaw arc.

In some embodiments, the virtual hat is generated using a view of the virtual aligned jaw and corresponding virtual antagonist jaw and information about the preparations/virtual pontics positions. The information about the preparations/virtual pontic positions can be added as an independent input virtual image with marks on preparation/pontic positions.

In some embodiments, the virtual hat follows the original virtual jaw everywhere except for one or more regions of reconstruction, where the virtual hat provides information regarding height in the occlusal direction and orientation (approximate unit contour) for virtual single dental units to be generated.

In some embodiments, the virtual hat is generated using a trained virtual hat generating DNN. In some embodiments, the trained virtual hat generating DNN can include a U-Net neural network. In some embodiments, the virtual hat generating DNN is provided an occlusal projection of the aligned virtual jaw under consideration and the virtual antagonist jaw, positions of the preparations (cavities) and predicted virtual pontic positions. In some embodiments, the virtual hat generating DNN converts 2D virtual images of the aligned virtual jaw, the virtual antagonist jaw, the preparations and virtual pontic positions to a 2D virtual image of an occlusal view of an approximate virtual reconstructed jaw as it should appear with pontic and preparation positions. The virtual pontic positions can be denoted by circles of fixed size. The approximate virtual reconstructed jaw can include information about position of one or more single virtual dental units in the virtual teeth arc and the height of each single virtual dental unit. In some embodiments, the height of each single virtual dental unit can be based on a distance to the antagonist virtual jaw.

In some embodiments, the virtual hat sees an overall virtual jaw arc and provides position and size information regarding selection and placement of single virtual dental units. The generated virtual hat can be used to determine precise single virtual dental units.

In some embodiments, generating the virtual hat can include generating an anterior virtual hat and generating a posterior virtual hat. In some embodiments, generating the anterior virtual hat can include using a trained anterior virtual hat generating DNN. In some embodiments, the trained anterior virtual hat generating DNN uses the determined anterior virtual jaw occlusion direction. In some embodiments, generating the posterior virtual hat can include using a trained posterior virtual hat generating DNN. In some embodiments, the trained posterior virtual hat generating DNN uses the determined posterior virtual jaw occlusion direction. In some embodiments, the virtual hat generating DNN is trained using a dataset of dental cases from a database, with at least one restoration and in some embodiments, the dataset can be enriched with dental cases with multiple restorations. The input can include (1) 1D projection of the virtual jaw from the occlusal direction (posterior or anterior, respectively), (2) centers of virtual preparations and predicted virtual pontics positions (“marks”/“circles”), (3) antagonist virtual jaw, and the target can be an occlusal projection of the reconstructed virtual jaw. In some embodiments, the anterior virtual hat generating DNN is trained using a dataset comprising anterior virtual jaws and the posterior virtual hat generating DNN is trained using a dataset comprising posterior virtual jaws. In some embodiments, the predicted pontics centers are shown to tell a single dental unit generating neural network (DNN) which single dental units should be reconstructed. In some embodiments, where the substantial number of cases after reconstruction by technician have blanks instead of possible pontics, the virtual hat generating DNN can determine whether to “draw” a pontic at a position or just leave a bald gingiva. In some embodiments, the (2) antagonist virtual jaw “delimits” (tells the virtual hat generating DNN) the virtual hat in occlusal direction.

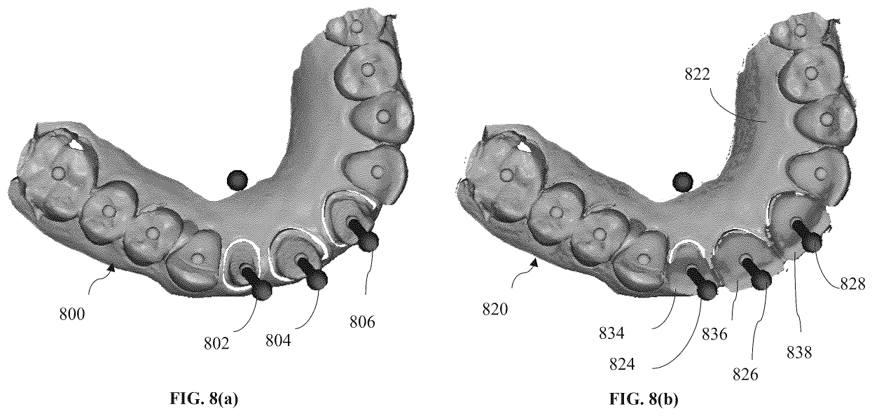

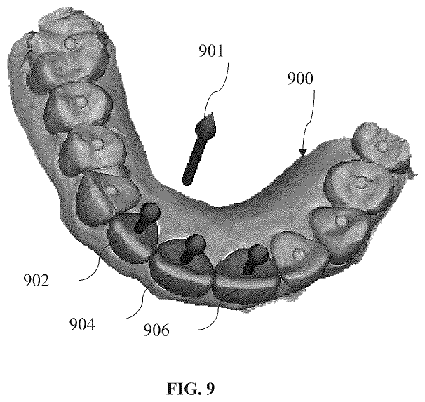

FIG. 8(a) and FIG. 8(b) show virtual hat generation in some embodiments. FIG. 8(a) shows a virtual jaw 800 prior to virtual hat generation. The virtual jaw 800 can include single virtual dental unit position(s) such as a first single virtual dental unit location 802, a second single virtual dental unit location 804, and a third single virtual dental unit location 806. In some embodiments, one or more of the single virtual dental units can include pontics and/or restorations. FIG. 8(b) shows a virtual jaw 820 after virtual hat generation. The generated virtual hat 822 follows the contours of the original virtual jaw 820 in all regions except those of the individual single dental units. For example, the virtual hat 822 follows the virtual jaw 820 surface everywhere except at first single dental unit position 824, second single dental unit position 826, and third single dental unit position 828. There, the virtual hat includes height and orientation (approximate unit contour) information for the single virtual dental units. For example, the virtual hat 822 provides height and orientation information such as first single virtual dental information 834, second single virtual dental unit information 836, and third single virtual dental unit information 838.

In some embodiments, providing virtual reconstructions can include determining one or more precise virtual pontic positions corresponding to the one or more rough virtual pontic positions using the generated virtual hat to provide one or more corresponding predicted virtual pontic position(s). The generated virtual hat can include the anterior virtual hat and the posterior virtual hat.

In some embodiments, determining precise virtual pontic positions can include localizing virtual teeth on the virtual hat. Localizing can be performed on the occlusal view of the generated virtual hat. In some embodiments, the anterior occlusal view is used for the anterior virtual hat and the posterior occlusal view is used for the posterior virtual hat. Localizing can utilize segmented virtual teeth.

In some embodiments, determining precise virtual pontic positions can include determining a correspondence between the rough virtual pontic position centers and localized virtual pontic position centers. In some embodiments, the localized virtual pontic position centers have same IDs as rough virtual pontic position centers.

In some embodiments, providing virtual reconstructions can include determining a buccal direction (if presented) for each virtual pontic/dental unit. In some embodiments, reconstructing each virtual single dental unit can include determining the buccal direction for the particular virtual single dental unit. In some embodiments, the buccal direction is determined by a trained DNN. In some embodiments, the trained DNN is a buccal trained DNN. In some embodiments, the buccal trained DNN is provided an occlusal view of the virtual jaw under consideration and a quadrant of the virtual jaw under consideration where a point for which the buccal direction is required. In some embodiments, the view is centered on the point for which a buccal direction is required. In some embodiments, the point can include a preparation center or pontic position. In some embodiments, the quadrant is a quadrant where the point for which the buccal direction is required is situated. In some embodiments, providing the quadrant advantageously avoids a flip of the buccal direction where an outer direction of the virtual jaw under consideration is not evident from the shape of the virtual jaw. In some embodiments, the trained buccal direction DNN is inferenced one or more times starting from various initial orientations of the virtual jaw under consideration on the occlusal view. In some embodiments, the buccal direction for the point is determined as an average of the results of the trained buccal direction DNN. In some embodiments, the trained buccal direction DNN is inferenced 10 times. In some embodiments, the trained buccal direction DNN can include a trained ResNet neural network.

In some embodiments, buccal direction DNN is trained using a dataset of dental cases from the database with at least one unit under reconstruction (UuR), the input is 1D projection of the virtual jaw from the posterior occlusal direction centered on the UuR, and the target is buccal direction of the UuR from the case. In some embodiments, the number of dental cases is 100 k dental cases.

In some embodiments, providing virtual reconstructions can include generating one or more virtual single dental units. In some embodiments, the one or more virtual single dental units can include virtual 3D models. The virtual 3D models can include outer surfaces, mesh and an inner part using standard geometrical methods.

In some embodiments, generating one or more virtual single dental units can include using a spherical coordinate system to determine spherical views corresponding to each of the one or more virtual single dental units to be generated. In some embodiments, determining spherical views for each of one or more virtual single dental units to be generated can include determining a center for each virtual crown to be generated. In some embodiments, a center of a virtual crown belonging to a particular preparation is determined as a center of a margin line of the particular preparation and ⅔ of the distance between virtual gingiva and the virtual hat above the virtual gingiva. In some embodiments, determining spherical views for each of one or more virtual single dental units to be generated can include determining a center for each virtual pontic to be generated. In some embodiments, the center of each virtual pontic to be generated is determined in the occlusal plane as the predicted virtual pontic center and ⅔ of the distance between virtual gingiva and the virtual hat above the virtual gingiva. In some embodiments, a polar axis extends through the buccal direction of the virtual single dental unit.

In some embodiments, the one or more virtual single dental units are generated using a trained DNN. In some embodiments, the one or more virtual single dental units are generated using a trained virtual dental unit generating DNN. In some embodiments, the trained virtual dental unit generating DNN can include U-Net. In some embodiments, the trained virtual dental unit generating DNN is provided one or more spherical views, each spherical view corresponding to a virtual single dental unit to be generated. In some embodiments, spherical views can include 2D depth maps. In some embodiments, spatial coordinates of the 2D depth map correspond to polar and azimuthal angles and the depth at a given coordinate corresponds to a radial distance to the surface of gingiva and neighboring teeth, antagonist jaw, preparation (for crowns only), and/or generated virtual hat. In some embodiments, the trained virtual dental unit generating DNN provides a spherical view of each virtual single dental unit generated. In some embodiments, the spherical view of the single dental unit generated is transformed back to three dimensions and meshed using standard geometrical algorithms known in the art. In some embodiments, the standard geometrical algorithm can include first constructing a point cloud from spherical projection to 3D. This can be performed as follows: for each point on the projection the phi and theta are (scaled) (x,y)-coordinates of the point of the projection, and the value at the point is the radius. Next, with the help of 3D geometry, the point cloud is meshed, obtaining a manifold surface (surface without too long edges, etc.) In some embodiments, the trained virtual dental unit generating DNN uses the posterior occlusion direction.

In some embodiments, the virtual dental unit generating DNN is trained using a dataset comprising dental units, an input of spherical projection with posterior occlusal direction for all the units, input 2D views of: (1) the virtual jaw, (2) the antagonist virtual jaw, (3) the corresponding virtual hat, (4) the virtual preparation (for crowns only, there is no preparation for the pontic), and the target is a spherical projection of the unit made by technician. In some embodiments, the training dataset can include 10 k-20 k dental cases from the database for each unit. In some embodiments, the dataset is enriched with units with multiple reconstructions to determine dental cases where mesial and/or distal neighboring unit is/are missing.

In some embodiments, the one or more generated virtual single dental units respect the virtual hat. In some embodiments, the one or more generated virtual single dental units are generated locally. Thus, the single dental units can be generated locally using the virtual hat such that the local generation respects a global virtual jaw arc. In some embodiments, the global virtual jaw arc is in the 3D virtual model of a particular virtual jaw, and represents the actual global virtual jaw arc.

In some embodiments, the computer-implemented method can determine margin lines for the single dental units to be constructed based on the spherical coordinates. In some embodiments, margin lines can be detected using any standard margin determination technique known in the art.

In some embodiments, margin marking can be performed manually or automatically using any technique known in the art. In some embodiments, determining the margin lines for the single dental units can be performed as described using one or more techniques described in U.S. patent application Ser. No. 17/245,944 to Azernikov et al., published as U.S. Patent Publication number 20220350936, the entirety of which is incorporated by reference herein.

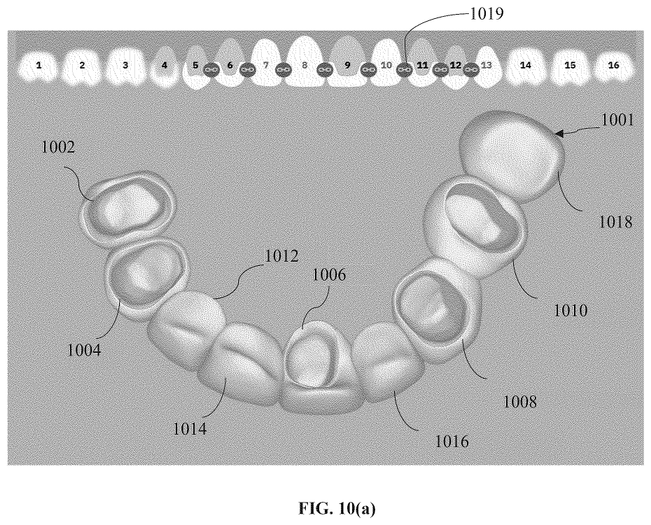

FIG. 9 shows an illustration of at least a portion of a virtual jaw with generated pontics and restorations within the virtual hat. A virtual jaw portion 900 having an occlusion direction 901 includes generated single virtual dental units such as first generated single virtual dental unit 902, second generated single virtual dental unit 904, and third generated single virtual dental unit 906.

In some embodiments, the generated virtual dental units can together form a virtual dental bridge, such as a virtual long dental bridge (a dental bridge with more than three virtual dental units). In some embodiments, the virtual dental bridge can be provided to CAD/CAM software for further processing. In some embodiments, the CAD/CAM software can be FastDesign by Glidewell Dental Laboratories. Other CAD/CAM software can also be used to further process the generated virtual dental bridge.

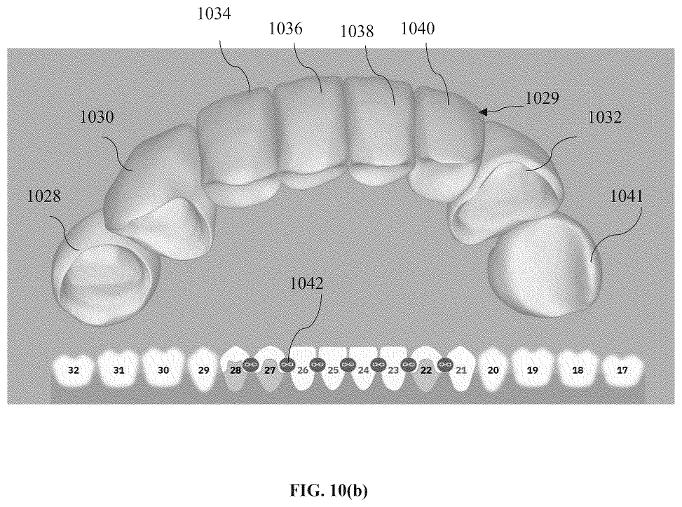

FIG. 10(a) and FIG. 10(b) show screenshots of the generated virtual dental bridge displayed in CAD/CAM software. FIG. 10(a) illustrates an example of a virtual dental bridge for a lower jaw in some embodiments. The lower virtual dental bridge 1001 can include virtual restorations such as first virtual restoration 1002, second virtual restoration 1004, third virtual restoration 1006, fourth virtual restoration 1008, and fifth virtual restoration 1010, for example. The virtual restorations can be crowns in some embodiments. The lower virtual dental bridge can also include one or more virtual pontics such as first virtual pontic 1012, second virtual pontic 1014, third virtual pontic 1016, and fourth virtual pontic 1018. The lower virtual dental bridge can also be displayed in a diagram of the virtual teeth, with elements of the lower virtual dental bridge connected by a visual indicator, such as a link indicator 1019.

FIG. 10(b) shows a screenshot of an upper virtual dental bridge 1029 that includes first virtual restoration 1028, second virtual restoration 1030 and third virtual restoration 1032. The upper virtual dental bridge 1029 can also include one or more virtual pontics, such as first virtual pontic 1034, second virtual pontic 1036, third virtual pontic 1038, fourth virtual pontic 1040, and fifth virtual pontic 1041. The upper virtual dental bridge 1029 can also be displayed in a diagram of the virtual teeth, with elements of the upper virtual dental bridge 1029 connected by a visual indicator, such as a link indicator 1042.

In some embodiments, the virtual dental bridge can be provided to a manufacturing facility to physically produce the bridge using any manufacturing technique known in the art, including but not limited to 3D additive manufacturing processes in combination with CAD/CAM software known in the art.

One or more advantages of one or more features can include, for example, can include allowing anterior and posterior occlusion directions to both be visible from the top, increasing accuracy in placement and orientation of virtual dental units within the arch. One or more advantages of one or more features can include, for example, determining a standard aligned position to allow further processing using one or more trained neural networks. One or more advantages can include speed of determining rough pontic positions, for example. One or more advantages can include, for example, avoiding a flip of the buccal direction where an outer direction of the virtual jaw under consideration is not evident from the shape of the virtual jaw. One or more advantages can include, for example, accurate placement and orientation of virtual dental units within the arch of a patient's jaw. One or more advantages can include, for example, accurate placement and orientation of the virtual dental bridge within the arch of a patient's jaw. One or more advantages can include, for example, design of dental bridges that account for the arch of a patient's jaw. One or more advantages can include, for example, adherence to the curve of the patient's jaw as interconnected virtual dental units are added to a dental bridge. One or more advantages can include design of dental bridges accounting for alignment of virtual dental units within the arch of a patient's jaw. One or more advantages can include, for example, allowing for an arbitrary number of virtual dental units to be part of a virtual dental bridge. One or more advantages can include, for example, allowing for construction of a virtual long dental bridge.

Some embodiments include a processing system for providing one or more virtual dental units as part of a virtual dental bridge. The processing system can include a processor, a computer-readable storage medium including instructions executable by the processor to perform steps including one or more features as described herein.

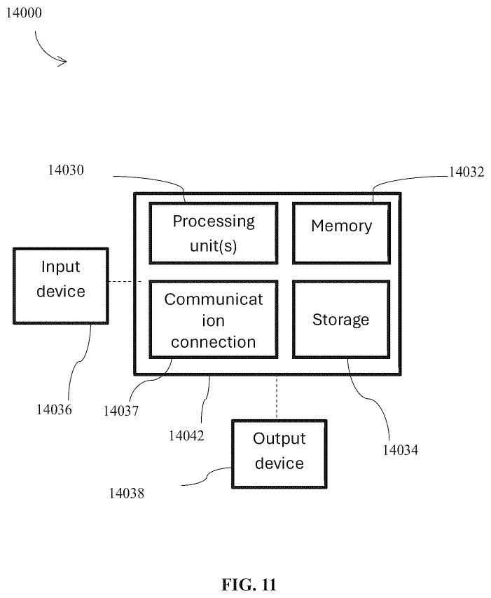

FIG. 11 illustrates a processing system 14000 in some embodiments. The system 14000 can include a processor 14030, computer-readable storage medium 14034 having instructions executable by the processor to perform one or more steps described in the present disclosure. In some embodiments, one or more features can be performed by a user, for example. Some embodiments can include one or more of the features described in the present disclosure. In some embodiments, one or more features can be performed automatically and/or can be performed by a user using an input device while viewing the digital model on a display, for example. In some embodiments, the computer-implemented method can allow the input device to manipulate the digital model displayed on the display. For example, in some embodiments, the computer-implemented method can rotate, zoom, move, and/or otherwise manipulate the digital model in any way as is known in the art. In some embodiments, one or more features can be performed by a user using the input device. In some embodiments, one or more features can be initiated, for example, using techniques known in the art, such as a user selecting another button.

In some embodiments the computer-implemented method can display a digital model on a display and receive input from an input device such as a mouse or touch screen on the display for example. For example, the computer-implemented method can receive an order for a dental bridge from a user. The computer-implemented method can, upon receiving an initiation command, perform using one or more features described in the present disclosure. The computer-implemented method can, upon receiving manipulation commands, rotate, zoom, move, and/or otherwise manipulate the digital model in any way as is known in the art and/or generate one or more virtual dental units to be part of a virtual dental bridge.

One or more of the features disclosed herein can be performed and/or attained automatically, without manual or user intervention. One or more of the features disclosed herein can be performed by a computer-implemented method. The features-including but not limited to any methods and systems-disclosed may be implemented in computing systems. For example, the computing environment 14042 used to perform these functions can be any of a variety of computing devices (e.g., desktop computer, laptop computer, server computer, tablet computer, gaming system, mobile device, programmable automation controller, video card, etc.) that can be incorporated into a computing system comprising one or more computing devices. In some embodiments, the computing system may be a cloud-based computing system.

For example, a computing environment 14042 may include one or more processing units 14030 and memory 14032. The processing units execute computer-executable instructions. A processing unit 14030 can be a central processing unit (CPU), a processor in an application-specific integrated circuit (ASIC), or any other type of processor. In some embodiments, the one or more processing units 14030 can execute multiple computer-executable instructions in parallel, for example. In a multi-processing system, multiple processing units execute computer-executable instructions to increase processing power. For example, a representative computing environment may include a central processing unit as well as a graphics processing unit or co-processing unit. The tangible memory 14032 may be volatile memory (e.g., registers, cache, RAM), non-volatile memory (e.g., ROM, EEPROM, flash memory, etc.), or some combination of the two, accessible by the processing unit(s). The memory stores software implementing one or more innovations described herein, in the form of computer-executable instructions suitable for execution by the processing unit(s).

A computing system may have additional features. For example, in some embodiments, the computing environment includes storage 14034, one or more input devices 14036, one or more output devices 14038, and one or more communication connections 14037. An interconnection mechanism such as a bus, controller, or network, interconnects the components of the computing environment. Typically, operating system software provides an operating environment for other software executing in the computing environment, and coordinates activities of the components of the computing environment.

The tangible storage 14034 may be removable or non-removable, and includes magnetic or optical media such as magnetic disks, magnetic tapes or cassettes, CD-ROMs, DVDs, or any other medium that can be used to store information in a non-transitory way and can be accessed within the computing environment. The storage 14034 stores instructions for the software implementing one or more innovations described herein.

The input device(s) may be, for example: a touch input device, such as a keyboard, mouse, pen, or trackball; a voice input device; a scanning device; any of various sensors; another device that provides input to the computing environment; or combinations thereof. For video encoding, the input device(s) may be a camera, video card, TV tuner card, or similar device that accepts video input in analog or digital form, or a CD-ROM or CD-RW that reads video samples into the computing environment. The output device(s) may be a display, printer, speaker, CD-writer, or another device that provides output from the computing environment.

The communication connection(s) enable communication over a communication medium to another computing entity. The communication medium conveys information, such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Any of the disclosed methods can be implemented as computer-executable instructions stored on one or more computer-readable storage media 14034 (e.g., one or more optical media discs, volatile memory components (such as DRAM or SRAM), or nonvolatile memory components (such as flash memory or hard drives)) and executed on a computer (e.g., any commercially available computer, including smart phones, other mobile devices that include computing hardware, or programmable automation controllers) (e.g., the computer-executable instructions cause one or more processors of a computer system to perform the method). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media 14034. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, Python, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, elecfromagnetic communications (including RF, microwave, and infrared communications), electronic communications, or other such communication means.

In view of the many possible embodiments to which the principles of the disclosure may be applied, it should be recognized that the illustrated embodiments are only examples and should not be taken as limiting the scope of the disclosure.

What is claimed is:

1. A computer-implemented method for dental bridge reconstructions, comprising:
receiving an order for a plurality of single dental units for reconstruction;
receiving a 3D virtual model of each jaw of a patient's dentition; and
providing virtual reconstructions of the plurality of single dental units as part of a virtual dental bridge.

2. The method of claim 1, wherein providing virtual reconstructions comprises using one or more trained neural networks.

3. The method of claim 1, wherein providing virtual reconstructions comprises providing virtual reconstructions comprises determining an occlusion direction in the 3D virtual model of the one or more virtual jaws.

4. The method of claim 1, wherein providing virtual reconstructions comprises aligning a 3D virtual model of a particular virtual jaw under reconstruction to a standard aligned position to provide an aligned virtual jaw.

5. The method of claim 1, wherein providing virtual reconstructions comprises determining rough virtual pontic positions of one or more virtual pontics in the 3D virtual model of the particular jaw under reconstruction.

6. The method of claim 5, wherein providing virtual reconstructions comprises generating a virtual hat in the 3D virtual model for the particular virtual jaw under reconstruction.

7. The method of claim 6, wherein providing virtual reconstructions comprises determining one or more precise virtual pontic positions corresponding to the one or more rough virtual pontic positions using the generated virtual hat to provide one or more corresponding predicted virtual pontic position(s) and generating one or more virtual single dental units.

8. A non-transitory computer readable medium storing executable computer program instructions to provide dental bridge reconstructions, the computer program instructions comprising instructions for:
receiving an order for a plurality of single dental units for reconstruction;
receiving a 3D virtual model of each jaw of a patient's dentition; and
providing virtual reconstructions of the plurality of single dental units as part of a virtual dental bridge.

9. The medium of claim 8, wherein providing virtual reconstructions comprises providing virtual reconstructions comprises determining an occlusion direction in the 3D virtual model of the one or more virtual jaws.

10. The medium of claim 8, wherein providing virtual reconstructions comprises aligning a 3D virtual model of a particular virtual jaw under reconstruction to a standard aligned position to provide an aligned virtual jaw.

11. The medium of claim 8, wherein providing virtual reconstructions comprises determining rough virtual pontic positions of one or more virtual pontics in the 3D virtual model of the particular jaw under reconstruction.

12. The medium of claim 11, wherein providing virtual reconstructions comprises generating a virtual hat in the 3D virtual model for the particular virtual jaw under reconstruction.

13. The medium of claim 12, wherein providing virtual reconstructions comprises determining one or more precise virtual pontic positions corresponding to the one or more rough virtual pontic positions using the generated virtual hat to provide one or more corresponding predicted virtual pontic position(s) and generating one or more virtual single dental units.

14. A system to provide one or more dental bridge reconstructions, the system comprising:
a processor; and
a non-transitory computer-readable storage medium comprising instructions executable by the processor to perform steps comprising:
receiving an order for a plurality of single dental units for reconstruction;
receiving a 3D virtual model of each jaw of a patient's dentition; and
providing virtual reconstructions of the plurality of single dental units as part of a virtual dental bridge.

15. The system of claim 14, wherein providing virtual reconstructions comprises using one or more trained neural networks.

16. The system of claim 14, wherein providing virtual reconstructions comprises providing virtual reconstructions comprises determining an occlusion direction in the 3D virtual model of the one or more virtual jaws.

17. The system of claim 14, wherein providing virtual reconstructions comprises aligning a 3D virtual model of a particular virtual jaw under reconstruction to a standard aligned position to provide an aligned virtual jaw.

18. The system of claim 14, wherein providing virtual reconstructions comprises determining rough virtual pontic positions of one or more virtual pontics in the 3D virtual model of the particular jaw under reconstruction.

19. The system of claim 18, wherein providing virtual reconstructions comprises generating a virtual hat in the 3D virtual model for the particular virtual jaw under reconstruction.

20. The system of claim 19, wherein providing virtual reconstructions comprises determining one or more precise virtual pontic positions corresponding to the one or more rough virtual pontic positions using the generated virtual hat to provide one or more corresponding predicted virtual pontic position(s) and generating one or more virtual single dental units.
